(19) United States
(12) Patent Application Publication
(10) Pub. No.: US 2025/0138136 A1
(43) Pub. Date: May 1, 2025

(54) POSITION ESTIMATION DEVICE, POSITION ESTIMATION SYSTEM, CONTROL CIRCUIT, STORAGE MEDIUM, AND POSITION ESTIMATION METHOD

(71) Applicant: MITSUBISHI ELECTRIC CORPORATION, Tokyo (JP)

(72) Inventors: Hiroyasu SANO, Tokyo (JP); Shusaku UMEDA, Tokyo (JP); Akira KURITA, Tokyo (JP)

(73) Assignee: MITSUBISHI ELECTRIC CORPORATION, Tokyo (JP)

(21) Appl. No.: 19/010,888

(22) Filed: Jan. 6, 2025

Related U.S. Application Data
(63) Continuation of application No. PCT/JP2022/034826, filed on Sep. 16, 2022.

(51) Int. Cl. G01S 5/14

(52) U.S. Cl. CPC G01S 5/14

(57) ABSTRACT

A mobile station that is a position estimation device that estimates a position of the mobile station based on a plurality of distance measurement results measured between each of a plurality of fixed stations and the mobile station using wireless communication includes: a positioning calculation unit that calculates a coordinate-axial position of the mobile station for each coordinate axis using a position of the fixed stations and the distance measurement results in order from a coordinate axis having a largest coordinate-axial distance between the plurality of fixed stations; and a position estimation result generation unit that generates a position estimation result indicating a three-dimensional position of the mobile station based on a calculation result of the coordinate-axial position.

### CROSS-REFERENCE TO RELATED APPLICATION

This application is a continuation application of International Application PCT/JP2022/034826, filed on Sep. 16, 2022, and designating the U.S., the entire contents of which are incorporated herein by reference.

### BACKGROUND OF THE INVENTION

### 1. Field of the Invention

The present disclosure relates to a position estimation device, a position estimation system, a control circuit, a storage medium, and a position estimation method for estimating a position based on a distance measurement result using a transmission/reception timing of communication.

### 2. Description of the Related Art

Techniques are available in which the distance between a fixed station fixed on the ground and a mobile station is measured from the propagation time between the fixed station and the mobile station using the transmission/reception timing of communication, and the position of the mobile station is estimated using known position information of the fixed station and the distance measurement result. A general algorithm for use in position estimation is a least squares method of solving three-dimensional nonlinear simultaneous equations relating to positions of three or more fixed stations and distance measurement results between the fixed stations and the mobile station in order to determine the three-dimensional position (x, y, z) of the mobile station, and the position of the mobile station is estimated by sequential approximate calculation.

In such a field, it is desired to improve the position estimation accuracy. For example, Japanese Patent No. 4567093 discloses a technique for improving the position estimation accuracy of a method of estimating the position of the mobile station from distance measurement results using ultra-wide band (UWB) signals, by identifying whether radio wave propagation between a fixed station and the mobile station is in a “line-of-sight” state or a “non-line-of-sight” state based on statistical data of multipath components included in a received signal, and applying a weight that reduces the influence of the distance measurement result for the fixed station in the “non-line-of-sight”state when estimating the position.

However, in the above-described conventional technique, it is necessary to collect statistical data of multipath components included in a received signal such as sharpness of the reception waveform, average excess delay spread of multipath components, and delay spread of a root mean square in advance for each area in which position estimation is performed, and there is a problem that position estimation cannot be performed with high accuracy in a case where statistical data cannot be collected in advance, in a case where the accuracy of statistical data is low, or the like.

### SUMMARY OF THE INVENTION

In order to solve the above-described problems and achieve the object, a position estimation device according to the present disclosure is a position estimation device that estimates a position of a mobile station based on a plurality of distance measurement results measured between each of a plurality of fixed stations and the mobile station using wireless communication. The position estimation device includes a positioning calculation unit to calculate a coordinate-axial position of the mobile station for each coordinate axis using a position of the fixed stations and the distance measurement results in order from a coordinate axis having a largest coordinate-axial distance between the plurality of fixed stations; and a position estimation result generation unit to generate a position estimation result indicating a three-dimensional position of the mobile station based on a calculation result of the coordinate-axial position.

### BRIEF DESCRIPTION OF THE DRAWINGS

FIG. 1 is a diagram illustrating an exemplary configuration of a position estimation system according to the first embodiment;

FIG. 2 is a diagram illustrating an example of waveform distortion that occurs in a multipath environment;

FIG. 3 is a diagram illustrating the relationship between distance measurement results between the mobile station and the fixed stations and position estimation;

FIG. 4 is a diagram illustrating a functional configuration of the mobile station which is the position estimation device according to the first embodiment;

FIG. 5 is a flowchart for explaining the operation of the mobile station according to the first embodiment;

FIG. 6 is a diagram illustrating a functional configuration of a mobile station which is the position estimation device according to the second embodiment;

FIG. 7 is a diagram illustrating an exemplary configuration of a position estimation system according to the second embodiment;

FIG. 8 is a diagram illustrating a state in which there is an error in the distance measurement result for the fixed station in the position estimation system;

FIG. 9 is a diagram for explaining a first example of a selection method by the fixed station selection unit;

FIG. 10 is a diagram for explaining a second example of a selection method by the fixed station selection unit;

FIG. 11 is a diagram for explaining a third example of a selection method by the fixed station selection unit;

FIG. 12 is a diagram for explaining the effect of the second embodiment;

FIG. 13 is a flowchart for explaining the operation of the mobile station according to the second embodiment;

FIG. 14 is a diagram illustrating a configuration of a position estimation system according to the third embodiment;

FIG. 15 is a diagram illustrating a functional configuration of the mobile station according to the third embodiment;

FIG. 16 is a diagram illustrating a first example of a positional relationship between the fixed stations and the mobile station according to the fourth embodiment;

FIG. 17 is a diagram illustrating a second example of a positional relationship between the fixed stations and the mobile station according to the fourth embodiment;

FIG. 18 is a diagram illustrating a functional configuration of the mobile station according to the fourth embodiment;

FIG. 19 is a flowchart for explaining the operation of the mobile station according to the fourth embodiment;

FIG. 20 is a diagram illustrating a functional configuration of a mobile station according to the fifth embodiment;

FIG. 21 is a flowchart for explaining the operation of the mobile station according to the fifth embodiment;

FIG. 22 is a diagram illustrating a configuration of the control circuit included in the fixed station or the mobile stations according to the first to fifth embodiments; and

FIG. 23 is a diagram illustrating an example of dedicated hardware included in the fixed station or the mobile stations according to the first to fifth embodiments.

### DETAILED DESCRIPTION OF THE PREFERRED EMBODIMENTS

Hereinafter, a position estimation device, a position estimation system, a control circuit, a storage medium, and a position estimation method according to embodiments of the present disclosure will be described in detail with reference to the drawings.

### First Embodiment

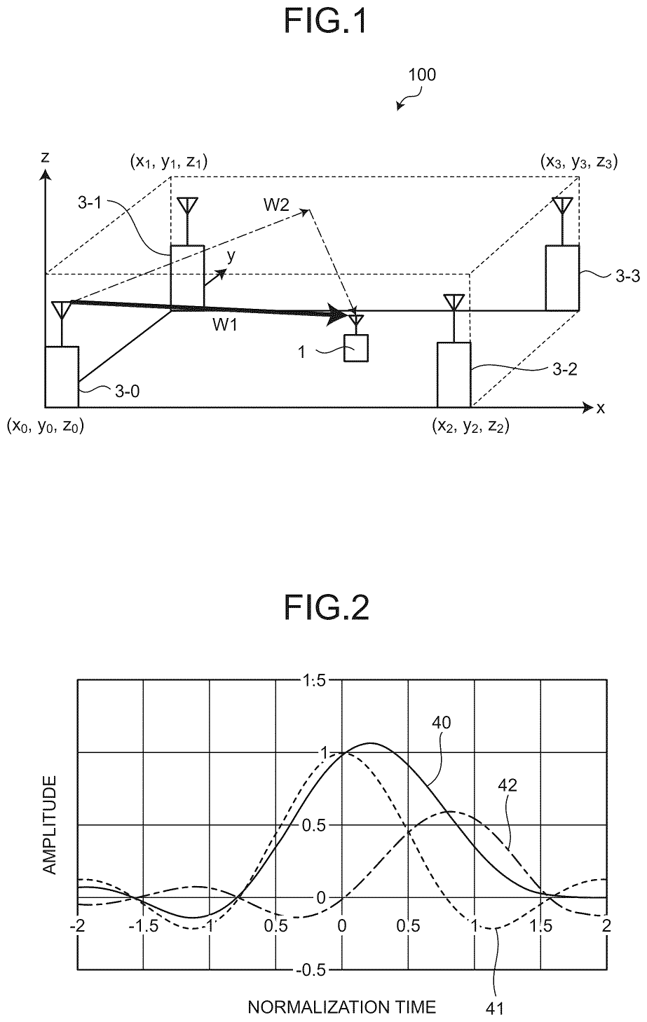

FIG. 1 is a diagram illustrating an exemplary configuration of a position estimation system 100 according to the first embodiment. The position estimation system 100 includes a mobile station 1, which is an example of a position estimation device, and a plurality of fixed stations 3-0 to 3-3 fixed to the ground. Note that, in the following description, when it is not necessary to distinguish the fixed stations 3-0 to 3-3 from each other, they may be simply referred to as the fixed station(s) 3. Here, four fixed stations 3 are illustrated, but the number of fixed stations 3 is not limited to four, and only needs to be two or more.

The position estimation system 100 measures the distance between the mobile station 1 and each of the plurality of fixed stations 3 based on the transmission/reception timing of a wireless signal transmitted/received by wireless communication between the mobile station 1 and each of the plurality of fixed stations 3, and estimates the position of the mobile station 1 based on the distance measurement result.

Here, wireless signals used by the position estimation system 100 are, for example, UWB signals. UWB signals are ultrashort pulse signals in the time domain. Therefore, the use of UWB signals makes it possible to grasp the transmission/reception timing of communication with high resolution, and to estimate the position of the mobile station 1 with high accuracy.

The positions of the mobile station 1 and the fixed station 3 are represented by three-dimensional positions, and coordinate axes defining the three-dimensional space are an x-axis, a y-axis, and a z-axis.

It is assumed that the position of the fixed station 3 is known, the position of the fixed station 3-0 is (x₀, y₀, z₀), the position of the fixed station 3-1 is (x₁, y₁, z₁), the position of the fixed station 3-2 is (x₂, y₂, z₂), and the position of the fixed station 3-3 is (x₃, y₃, z₃).

Each fixed station 3 transmits a broadcast signal including position information and identification information thereof, for example, and the mobile station 1 can recognize information of the fixed station 3 capable of reception based on the broadcast signal. The mobile station 1 calculates the propagation time required for wireless communication based on the transmission/reception timing of the UWB signal between the mobile station 1 and each of the recognized fixed stations 3, and obtains the distance measurement result for each fixed station 3. When a UWB signal is transmitted and received between the mobile station 1 and each fixed station 3, in a case where there is an object that reflects radio waves such as a wall, a reflected wave W2 is received in addition to a direct wave W1. In this case, distortion occurs in the waveform of the UWB signal.

FIG. 2 is a diagram illustrating an example of waveform distortion that occurs in a multipath environment. As illustrated in FIG. 2, in the multipath environment, a reception waveform 40 detected on the reception side is distorted as a result of combining a waveform 41 of the direct wave W1 and a waveform 42 of the reflected wave W2. As illustrated in FIG. 2, the reception waveform 40 distorted has a signal waveform shifted backward in time as compared with the waveform 41 of the direct wave W1, and thus, the distance measurement result that is based on the reception waveform 40 tends to have a large distance. As the accuracy of the distance measurement result is reduced in this manner, the position estimation accuracy of the mobile station 1 that is based on the distance measurement result is also reduced.

The first embodiment proposes a position estimation method with which it is possible to prevent a decrease in position estimation accuracy even in a case where the accuracy of a distance measurement result is low as described above.

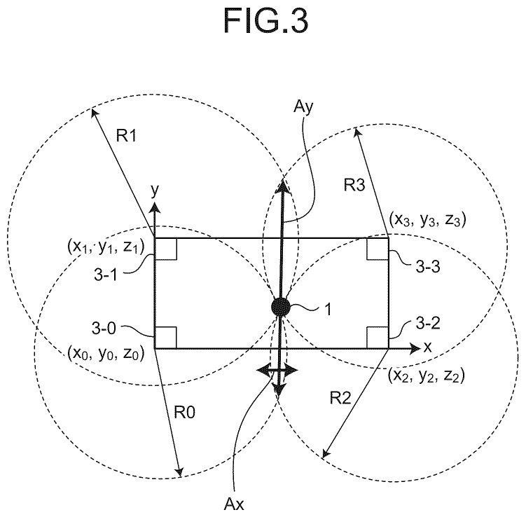

FIG. 3 is a diagram illustrating the relationship between distance measurement results between the mobile station 1 and the fixed stations 3 and position estimation. Here, the distance measurement result for the fixed station 3-0 is denoted by R0, the distance measurement result for the fixed station 3-1 is denoted by R1, the distance measurement result for the fixed station 3-2 is denoted by R2, and the distance measurement result for the fixed station 3-3 is denoted by R3. At this time, ideally, it is desirable that a circle having a radius of R0 and centered on the position of the fixed station 3-0, a circle having a radius of R1 and centered on the position of the fixed station 3-1, a circle having a radius of R2 and centered on the position of the fixed station 3-2, and a circle having a radius of R3 and centered on the position of the fixed station 3-3 intersect at one point, and the intersection be estimated as the position of the mobile station 1.

Here, suppose that calculation is performed based on the least squares method as a position estimation algorithm for positioning calculation. In this case, focusing on the z-axis direction and the y-axis direction, an estimation range Ax on the X-axis is smaller than an estimation range Ay on the Y-axis. This indicates that the position estimation result with respect to the X-axis can have a smaller error than the position estimation result with respect to the Y-axis. Here, the position estimation range decreases as the distance between the fixed stations 3 increases. Therefore, as a distance between the fixed stations 3 for each coordinate axis (the distance may be referred to as the coordinate-axial distance between the fixed stations 3) increases, the estimation range of the position in that coordinate axis direction decreases, and the position estimation error decreases. Therefore, in the first embodiment, the position of the mobile station 1 is calculated for each coordinate axis (the position may be referred to as the coordinate-axial position of the mobile station 1) by the one-dimensional least squares method in order from the coordinate axis having the largest distance between the fixed stations 3 among the plurality of coordinate axes, thereby reducing the estimation error of the position for each coordinate axis. Hereinafter, functions of the position estimation device for performing such processing will be described.

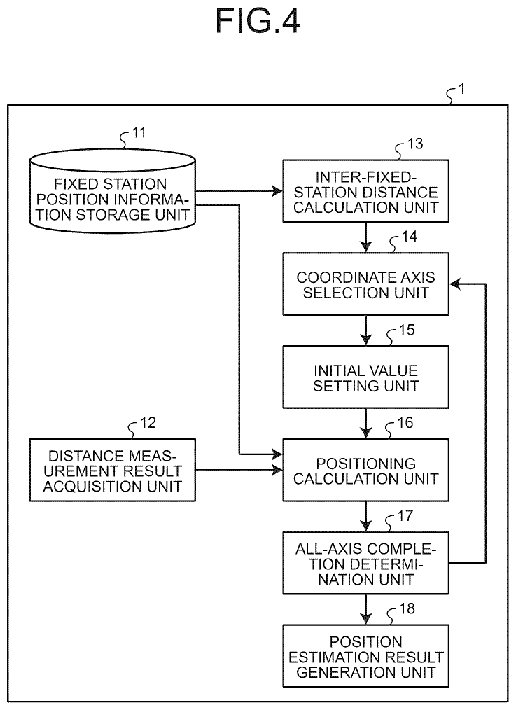

FIG. 4 is a diagram illustrating a functional configuration of the mobile station 1 which is the position estimation device according to the first embodiment. The mobile station 1 includes a fixed station position information storage unit 11 that stores position information of the fixed station 3, a distance measurement result acquisition unit 12 that acquires a distance measurement result between each fixed station 3 and the mobile station 1, an inter-fixed-station distance calculation unit 13 that calculates a distance between the fixed stations 3, a coordinate axis selection unit 14 that selects a coordinate axis to be calculated based on the distance between the fixed stations 3, an initial value setting unit 15 that sets an initial value for calculating a position for each coordinate axis, a positioning calculation unit 16 that calculates a position for each coordinate axis for the selected coordinate axis, an all-axis completion determination unit 17 that determines whether calculation of a position for each coordinate axis has been completed for all assumed coordinate axes, and a position estimation result generation unit 18 that generates a position estimation result indicating a three-dimensional position of the mobile station 1 based on the calculation result.

The fixed station position information storage unit 11 stores the position information of the fixed station 3 included in the broadcast signal transmitted from each fixed station 3. The position information is stored, for example, in association with the identification information included in the broadcast signal. For example, in the example illustrated in FIG. 1, in a case where the mobile station 1 receives the broadcast signals of the four fixed stations 3, i.e. the fixed stations 3-0 to 3-3, the fixed station position information storage unit 11 stores the position information (x₀, y₀, z₀) of the fixed station 3-0, the position information (x₁, y₁, z₁) of the fixed station 3-1, the position information (x₂, y₂, z₂) of the fixed station 3-2, and the position information (x₃, y₃, z₃) of the fixed station 3-3.

The distance measurement result acquisition unit 12 transmits and receives UWB signals to and from each fixed station 3, calculates the propagation time required for wireless communication based on the transmission/reception timing of each UWB signal, and acquires the distance measurement result for each fixed station 3. Note that, here, since the mobile station 1 has both the distance measurement function and the position estimation function, the distance measurement result acquisition unit 12 performs the distance measurement process itself. However, in a case where the distance measurement process is performed by a device different from the mobile station 1, the distance measurement result acquisition unit 12 only needs to acquire a distance measurement result that is a result of the distance measurement process performed by that device through communication.

The inter-fixed-station distance calculation unit 13 calculates the distance between the fixed stations 3 based on the position information of the plurality of fixed stations 3 stored in the fixed station position information storage unit 11. At this time, the inter-fixed-station distance calculation unit 13 calculates the distance for each coordinate axis. For example, in a case where the distance between the fixed stations 3 is calculated for the four fixed stations 3-0 to 3-3 illustrated in FIG. 1, in the example illustrated in FIG. 1, the four fixed stations 3-0 to 3-3 are disposed so as to be positioned at the respective vertexes of the rectangle on the xy plane, and thus, the relationship of Formula (1) below holds for the x-axis, the relationship of Formula (2) below holds for the y-axis, and the relationship of Formula (3) below holds for the z-axis.

$$Formula 1$$

$$( \vert {x}_{0} − {x}_{2} \vert = \vert {x}_{1} − {x}_{3} \vert = {d}_{1} ) > ( \vert {x}_{0} − {x}_{1} \vert = \vert {x}_{2} − {x}_{3} \vert = 0 ) \qquad ( 1 )$$

$$Formula 2$$

$$( \vert {y}_{0} − {y}_{1} \vert = \vert {y}_{2} − {y}_{3} \vert = {d}_{2} ) > ( \vert {y}_{0} − {y}_{2} \vert = \vert {y}_{1} − {y}_{3} \vert = 0 ) \qquad ( 2 )$$

$$Formula 3$$

$$\vert {z}_{0} − {z}_{1} \vert = \vert {z}_{1} − {z}_{2} \vert = \vert {z}_{2} − {z}_{3} \vert = \vert {z}_{3} − {z}_{0} \vert = {d}_{3} \qquad ( 3 )$$

It is assumed that the magnitudes of d₁, d₂, and d₃ in Formulas (1) to (3) satisfy the relationship of “d₁>d₂>d₃”. In this case, the distances between the fixed stations 3 for the respective axes are, in descending order, the x-axis, the y-axis, and the z-axis.

The inter-fixed-station distance calculation unit 13 can also calculate a distance between the fixed stations 3 for each coordinate axes using Formulas (4) to (6) below. Specifically, given that the number of fixed stations 3 is N, the distance between the fixed stations 3 on the x-axis is expressed by Formula (4) below, the distance between the fixed stations 3 on the y-axis is expressed by Formula (5) below, and the distance between the fixed stations 3 on the z-axis is expressed by Formula (6) below.

$$\begin{matrix}Formula 4 & \\ {\sum }_{n = 0}^{N - 1} {\sum }_{m = n + 1}^{N - 1} \vert {x}_{n} - {x}_{m} \vert & ( 4 )\end{matrix}$$

$$\begin{matrix}Formula 5 & \\ {\sum }_{n = 0}^{N - 1} {\sum }_{m = n + 1}^{N - 1} \vert {y}_{n} - {y}_{m} \vert & ( 5 )\end{matrix}$$

$$\begin{matrix}Formula 6 & \\ {\sum }_{n = 0}^{N - 1} {\sum }_{m = n + 1}^{N - 1} \vert {z}_{n} - {z}_{m} \vert & ( 6 )\end{matrix}$$

According to Formulas (4) to (6) above, for example, in a case where the position information of the four fixed stations 3-0 to 3-3 illustrated in FIG. 1 is stored in the fixed station position information storage unit 11, the inter-fixed-station distance calculation unit 13 calculates, for each coordinate axis, the sum of the distances between the fixed stations 3 of the six combinations: the fixed station 3-0 and the fixed station 3-1, the fixed station 3-0 and the fixed station 3-2, the fixed station 3-0 and the fixed station 3-3, the fixed station 3-1 and the fixed station 3-2, the fixed station 3-1 and the fixed station 3-3, and the fixed station 3-2 and the fixed station 3-3, as the distance between the fixed stations 3 for each coordinate axis.

Here, assuming that the conditions of Formulas (1) to (3) are satisfied for the four fixed stations 3-0 to 3-3 illustrated in FIG. 1, the value of Formula (4) is 4d₁, the value of Formula (5) is 4d₂, the value of Formula (6) is 4d₃, and the distances between the fixed stations 3 for the respective coordinate axes are, in descending order, the x-axis, the y-axis, and the z-axis.

Note that, here, for the sake of simplicity, the four fixed stations 3-0 to 3-3 are disposed as an example so as to be positioned at the respective vertexes of the rectangle on the xy plane, but the conditions indicated in Formulas (1) to (3) need not necessarily be satisfied.

The coordinate axis selection unit 14 selects coordinate axes in descending order of distance based on the distance between the fixed stations 3 calculated by the inter-fixed-station distance calculation unit 13. In the above example, the coordinate axis selection unit 14 sequentially selects coordinate axes in the order of the x-axis, the y-axis, and the z-axis. The coordinate axis selection unit 14 outputs information indicating the selected coordinate axes to the initial value setting unit 15.

The initial value setting unit 15 calculates the initial value of each axis for the positioning calculation unit 16 to calculate the position for each coordinate axis based on the selected coordinate axis. For example, the initial value setting unit 15 may use the average value of the positions of the plurality of fixed stations 3 as the initial value. In this case, the initial value xᵢₙ of the x-axis is expressed by Formula (7) below, the initial value yᵢₙ of the y-axis is expressed by Formula (8) below, and the initial value zᵢₙ of the z-axis is expressed by Formula (9) below.

$$\begin{matrix}Formula 7 & \\ {x}_{in} = \frac{1}{N} {\sum }_{n = 0}^{N - 1} {x}_{n} & ( 7 )\end{matrix}$$

$$\begin{matrix}Formula 8 & \\ {y}_{in} = \frac{1}{N} {\sum }_{n = 0}^{N - 1} {y}_{n} & ( 8 )\end{matrix}$$

$$\begin{matrix}Formula 9 & \\ {z}_{in} = \frac{1}{N} {\sum }_{n = 0}^{N - 1} {z}_{n} & ( 9 )\end{matrix}$$

Note that, in a case where the position of the mobile station 1 is calculated in advance in terms of time, the initial value setting unit 15 can use this position information as the initial value. For example, in a case where the position of the mobile station 1 is continuously calculated, and the three-dimensional position of the mobile station 1 has already been calculated within a time range that serves as a guide level for the position of the mobile station 1, the initial value setting unit 15 may use this position information as the initial value. In addition, in a case where the coordinate axes are selected in the order of the x-axis, the y-axis, and the z-axis, when the position of the x-axis is calculated, the initial value of the position of the mobile station 1 can be set to (xᵢₙ, yᵢₙ, zᵢₙ). When the position of the y-axis is calculated, since the position of the x-axis has already been calculated, the initial value of the position of the mobile station 1 can be set to (xₑₛₜ, yᵢₙ, zᵢₙ) using the calculated position estimation result xₑₛₜ of the x-axis, which is a fixed value. When the position of the z-axis is calculated, since the positions of the x-axis and the y-axis have already been calculated, the initial value of the position of the mobile station 1 can be set to (xₑₛₜ, yₑₛₜ, zᵢₙ) using the calculated position xₑₛₜ of the x-axis, which is a fixed value, and the calculated position yₑₛₜ of the y-axis, which is a fixed value.

With respect to the coordinate axes selected by the coordinate axis selection unit 14, the positioning calculation unit 16 calculates the position of the mobile station 1 for each coordinate axial based on the initial value of each axis set by the initial value setting unit 15, the position information of each fixed station 3 stored in the fixed station position information storage unit 11, and the distance measurement result for each fixed station 3 acquired by the distance measurement result acquisition unit 12.

Specifically, the positioning calculation unit 16 calculates the position of the mobile station 1 for each coordinate axis based on the one-dimensional least squares method. For example, in the above example, suppose that the coordinate axis selection unit 14 selects coordinate axes in the order of the x-axis, the y-axis, and the z-axis, and the positioning calculation unit 16 performs positioning calculation in the order of the x-axis, the y-axis, and the z-axis. At this time, in the case of estimating the position of the mobile station 1 in the x-axis direction which is selected first, the positioning calculation unit 16 sets the position of the mobile station 1 to (xᵢₙ, yᵢₙ, zᵢₙ) based on the output of the initial value setting unit 15, sets the variable of the x-axis to be estimated in positioning calculation to the initial value xₑₛₜ=xᵢₙ, and performs calculation. The distance rₙ between the n-th fixed station 3-n and the mobile station 1 to be subjected to position estimation is calculated based on Formula (10) below.

$$\begin{matrix}Formula 10 & \\ {r}_{n} = \sqrt{{( {x}_{n} - {x}_{est} )}^{2} + {( {y}_{n} - {y}_{in} )}^{2} + {( {z}_{n} - {z}_{in} )}^{2}} & ( 10 )\end{matrix}$$

Note that n is an integer of zero to N−1. In Formula (10), since rₙ is a nonlinear function related to xₑₛₜ, the positioning calculation unit 16 sequentially calculates the variable xₑₛₜ of the position estimation related to the x-axis based on the least squares method by sequential approximation using Formula (10) as a norm.

In addition, since there is a measurement error between the distance measurement result Rn and the distance rₙ between the n-th fixed station 3-n and the mobile station 1 for each of the N fixed stations, the positioning calculation unit 16 calculates the sum of squares E of the distance errors corresponding to the N fixed stations. The sum of squares E of the distance errors corresponding to the N fixed stations is expressed by Formula (11) below.

$$\begin{matrix}Formula 11 & \\ E = {\sum }_{n = 0}^{N - 1} {e}_{n}^{2} = {\sum }_{n = 0}^{N - 1} {( {R}_{n} - {r}_{n} )}^{2} & ( 11 )\end{matrix}$$

In the positioning calculation unit 16, the position estimation result xₑₛₜ of the x-axis of the mobile station 1 is output by the least squares method that is based on sequential approximation for minimizing the sum of squares E of the distance errors corresponding to the N fixed stations expressed by Formula (11).

Once the y-axis is selected next to the x-axis, the positioning calculation unit 16 sets the position of the mobile station 1 to (xₑₛₜ, yᵢₙ, zᵢₙ) based on the output of the initial value setting unit 15, sets the variable of the y-axis to be estimated in positioning calculation to the initial value yₑₛₜ=yᵢₙ, and performs calculation. In this case, the distance rₙ between the n-th fixed station 3-n and the mobile station 1 to be subjected to position estimation is calculated based on Formula (12) below. Note that n is an integer of zero to N−1. In Formula (12), since rₙ is a nonlinear function related to yₑₛₜ, the positioning calculation unit 16 sequentially calculates the variable yₑₛₜ of the position estimation related to the y-axis based on the least squares method by sequential approximation using Formula (12) as a norm.

$$\begin{matrix}Formula 12 & \\ {r}_{n} = \sqrt{{( {x}_{n} - {x}_{est} )}^{2} + {( {y}_{n} - {y}_{est} )}^{2} + {( {z}_{n} - {z}_{in} )}^{2}} & ( 12 )\end{matrix}$$

Note that, also in this case, since the sum of squares E of the distance errors corresponding to the N fixed stations is expressed by Formula (11) above, the positioning calculation unit 16 calculates the sum of squares E of the distance errors based on Formula (11), estimates the position of the y-axis of the mobile station 1 using the least squares method that is based on sequential approximation in order to minimize the sum of squares E of the distance errors, and outputs the position yₑₛₜ of the y-axis, which is the estimation result.

Once the z-axis is selected next to the x-axis and the y-axis, the positioning calculation unit 16 sets the position of the mobile station 1 to (xₑₛₜ, yₑₛₜ, zᵢₙ) based on the output of the initial value setting unit 15, sets the variable of the z-axis to be estimated in positioning calculation to the initial value zₑₛₜ=zᵢₙ, and performs calculation. In this case, the distance rₙ between the n-th fixed station 3-n and the mobile station 1 to be subjected to position estimation is calculated based on Formula (13) below. Note that n is an integer of zero to N−1. In Formula (13), since rₙ is a nonlinear function related to zₑₛₜ, the positioning calculation unit 16 sequentially calculates the variable zₑₛₜ of the position estimation related to the z-axis based on the least squares method by sequential approximation using Formula (13) as a norm.

$$\begin{matrix}Formula 13 & \\ {r}_{n} = \sqrt{{( {x}_{n} - {x}_{est} )}^{2} + {( {y}_{n} - {y}_{est} )}^{2} + {( {z}_{n} - {z}_{est} )}^{2}} & ( 13 )\end{matrix}$$

Note that, also in this case, since the sum of squares E of the distance errors corresponding to the N fixed stations is expressed by Formula (11) above, the positioning calculation unit 16 calculates the sum of squares E of the distance errors based on Formula (11), estimates the position of the z-axis of the mobile station 1 using the least squares method that is based on sequential approximation in order to minimize the sum of squares E of the distance errors, and outputs the position zₑₛₜ of the z-axis, which is the estimation result.

The all-axis completion determination unit 17 determines whether positioning calculation for the coordinate-axial position has been completed for all the coordinate axes assumed as the positioning targets, and in a case where positioning calculation for all the axes has not been completed yet, notifies the coordinate axis selection unit 14 to continue the selection of coordinate axes, and in a case where positioning calculation for all the axes has been completed, notifies the position estimation result generation unit 18 that positioning calculation for all the axes has been completed. For example, when receiving the calculation result of the coordinate-axial position for each coordinate axis from the positioning calculation unit 16 for three axes of the x-axis, the y-axis, and the z-axis, the all-axis completion determination unit 17 can notify the position estimation result generation unit 18 that positioning calculation for all the axes is completed, and in other cases, notify the coordinate axis selection unit 14 to continue the selection of coordinate axes. Alternatively, in a case where the position of one of the three axes, for example, the z-axis, is known in advance, the position estimation only needs to be performed for two axes of the x-axis and the y-axis, and the determination criterion of the all-axis completion determination unit 17 can be that the positioning calculation of the two axes is completed. Once the positioning calculation for all the axes is completed, the all-axis completion determination unit 17 outputs the calculation result received from the positioning calculation unit 16 to the position estimation result generation unit 18.

Upon receiving the calculation result of the coordinate-axial positions from the all-axis completion determination unit 17, the position estimation result generation unit 18 outputs (xₑₛₜ, yₑₛₜ, zₑₛₜ) as the position estimation result indicating the three-dimensional position of the mobile station 1 based on these calculation results.

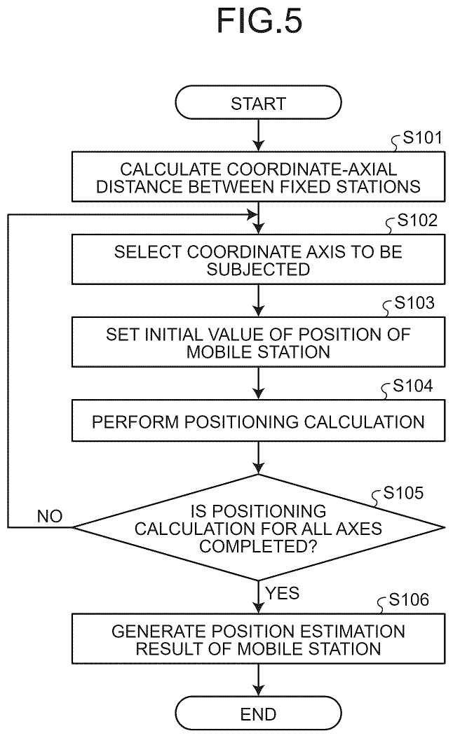

FIG. 5 is a flowchart for explaining the operation of the mobile station 1 according to the first embodiment. The inter-fixed-station distance calculation unit 13 calculates a distance between the fixed stations 3 for each coordinate axis, namely, a coordinate-axial distance between the fixed stations 3 (step S101). The coordinate axis selection unit 14 selects a coordinate axis to be subjected to positioning calculation (step S102). The initial value setting unit 15 sets the initial value of the position of the mobile station 1 (step S103). The positioning calculation unit 16 performs the positioning calculation of calculating the coordinate-axial position of the mobile station 1 using the set initial value for the selected coordinate axis (step S104).

The all-axis completion determination unit 17 determines whether positioning calculation for all axes is completed (step S105). The coordinate axes with unknown positions are set as coordinate axes to be subjected to positioning calculation, and the determination in step S105 is performed based on whether an estimated value of the coordinate-axial position for each coordinate axis has been calculated by positioning calculation for all the coordinate axes to be subjected to positioning calculation.

In response to a determination that positioning calculation for all axes has not been completed (step S105: No), the mobile station 1 returns to step S102. In response to a determination that positioning calculation for all axes is completed (step S105: Yes), the position estimation result generation unit 18 generates a position estimation result indicating the three-dimensional position of the mobile station 1 (step S106).

As described above, the mobile station 1, which is the position estimation device according to the first embodiment, is a position estimation device that estimates a position of the mobile station 1 based on a plurality of distance measurement results measured between each of a plurality of fixed stations 3 and the mobile station 1 using wireless communication, and includes: the positioning calculation unit 16 that calculates a coordinate-axial position of the mobile station 1 for each coordinate axis using a position of the fixed stations 3 and the distance measurement results in order from a coordinate axis having a largest coordinate-axial distance between the plurality of fixed stations 3; and the position estimation result generation unit 18 that generates a position estimation result indicating a three-dimensional position of the mobile station 1 based on a calculation result of the coordinate-axial position for each coordinate axis. The larger the coordinate-axial distance between the fixed stations 3, the smaller the position estimation range, so that the position estimation error can be reduced. Therefore, by performing positioning calculation in order from the coordinate axis having the largest distance between the fixed stations 3, it is possible to reduce the error in coordinate-axial position estimation for each coordinate axis and improve the position estimation accuracy. Thus, the position estimation can be performed with high accuracy even in a case where accurate statistical data of multipath components of a received signal cannot be obtained in advance.

In addition, even in a case where the number of fixed stations 3 which are installed in the area of the position estimation system 100 and can be used for distance measurement is not sufficiently large, or in a case where a distance measurement result with low distance measurement accuracy is included under the influence of a reflected wave due to a wall or the like, it is possible to reduce the number of coordinate axes to be estimated simultaneously and maintain the position estimation accuracy while reducing the degree of freedom of variables necessary for position estimation.

### Second Embodiment

In the first embodiment described above, positioning calculation is performed using all of the plurality of fixed stations 3 successfully recognized by the mobile station 1. However, in the second embodiment, positioning calculation is performed by selecting the fixed station 3 to be used in order to exclude, from the positioning calculation, a distance measurement result between the fixed station 3 and the mobile station 1 which is assumed to have a large distance measurement error.

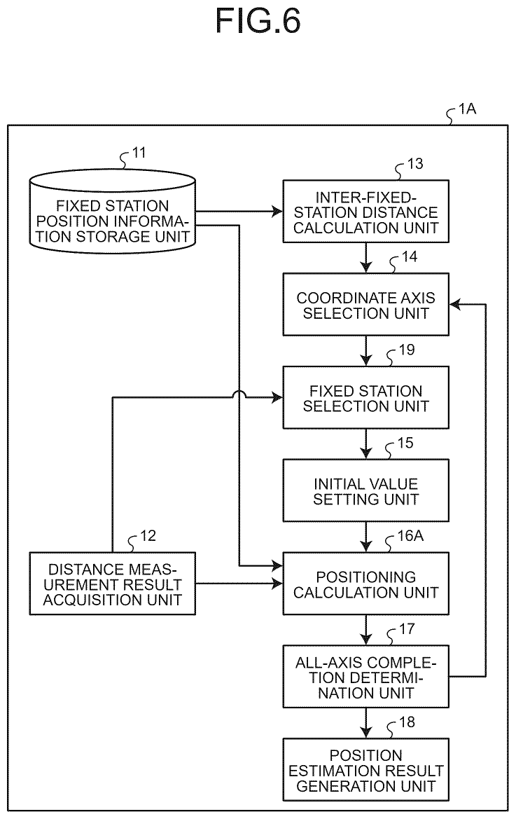

FIG. 6 is a diagram illustrating a functional configuration of a mobile station 1A which is the position estimation device according to the second embodiment. The mobile station 1A includes the fixed station position information storage unit 11, the distance measurement result acquisition unit 12, the inter-fixed-station distance calculation unit 13, the coordinate axis selection unit 14, a fixed station selection unit 19 that selects a fixed station 3 to use a distance measurement result in estimating a position from among a plurality of fixed stations 3, the initial value setting unit 15, a positioning calculation unit 16A, the all-axis completion determination unit 17, and the position estimation result generation unit 18. Note that the mobile station 1A includes the fixed station selection unit 19 in addition to the components of the mobile station 1 and includes the positioning calculation unit 16A instead of the positioning calculation unit 16, and other configurations are the same as those of the mobile station 1, and thus the detailed description thereof is omitted here. Hereinafter, differences from the first embodiment will be mainly described.

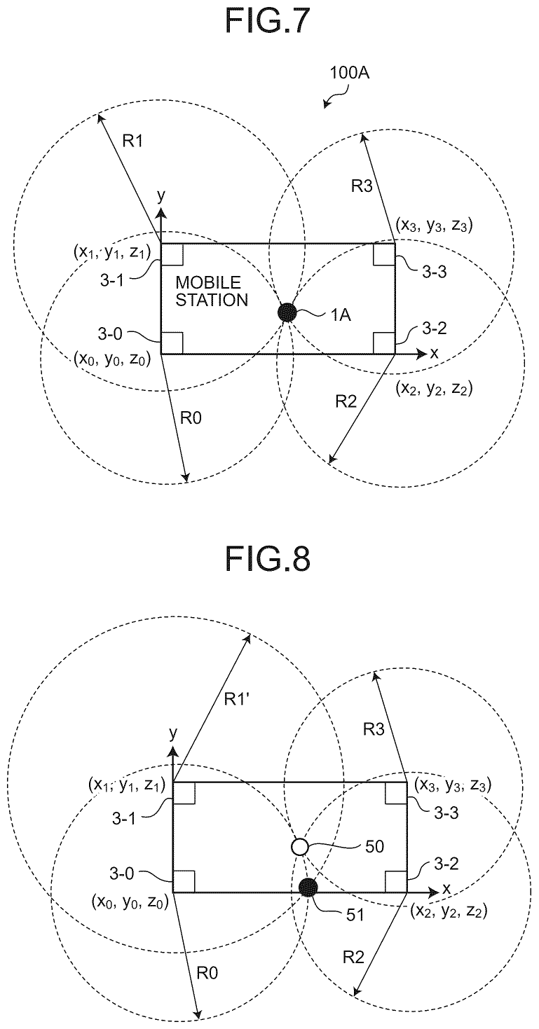

Here, the influence of a distance measurement error between the fixed station 3 and the mobile station 1 on positioning will be described. FIG. 7 is a diagram illustrating an exemplary configuration of a position estimation system 100A according to the second embodiment. FIG. 7 illustrates a state in which there is no distance measurement error.

The position estimation system 100A includes the mobile station 1A and the plurality of fixed stations 3-0 to 3-3. The positions of the mobile station 1A and the fixed station 3 are represented by three-dimensional positions, and coordinate axes defining the three-dimensional space are an x-axis, a y-axis, and a z-axis. It is assumed that the positions of the fixed stations 3 are known, the position of the fixed station 3-0 is (x₀, y₀, z₀), the position of the fixed station 3-1 is (x₁, y₁, z₁), the position of the fixed station 3-2 is (x₂, y₂, z₂), and the position of the fixed station 3-3 is (x₃, y₃, z₃).

The distance measurement result for the fixed station 3-0 is denoted by R0, the distance measurement result for the fixed station 3-1 is denoted by R1, the distance measurement result for the fixed station 3-2 is denoted by R2, and the distance measurement result for the fixed station 3-3 is denoted by R3. Since FIG. 7 illustrates a state in which there is no error in distance measurement results, a circle having a radius of R0 and centered on the position of the fixed station 3-0, a circle having a radius of R1 and centered on the position of the fixed station 3-1, a circle having a radius of R2 and centered on the position of the fixed station 3-2, and a circle having a radius of R3 and centered on the position of the fixed station 3-3 intersect at one point, and in this case, the intersection is estimated as the position of the mobile station 1A.

FIG. 8 is a diagram illustrating a state in which there is an error in the distance measurement result for the fixed station 3-1 in the position estimation system 100A. When waveform distortion due to a reflected wave occurs between the fixed station 3-1 and the mobile station 1A, a distance measurement result R1′ for the fixed station 3-1 including an error tends to be longer than the actual distance R1. In this case, using the distance measurement result R1′ for the estimation of the position of the mobile station 1A, a position 51 shifted from an original position 50 is estimated.

As described above, if a distance measurement result with a large error is included in position estimation, the estimated position also has a large error. In addition, the error of the distance measurement result tends to be larger as the distance between the mobile station 1A and the fixed station 3 is larger, that is, as the distance measurement result is larger. Therefore, the fixed station selection unit 19 selects the fixed station 3 to be used from among the plurality of fixed stations 3 based on the magnitude of the distance measurement results. In addition, the positioning calculation unit 16A uses the distance measurement result of the fixed station 3 selected by the fixed station selection unit 19, and excludes the distance measurement result of the fixed station 3 not selected by the fixed station selection unit 19 from the distance measurement results to be used for position calculation.

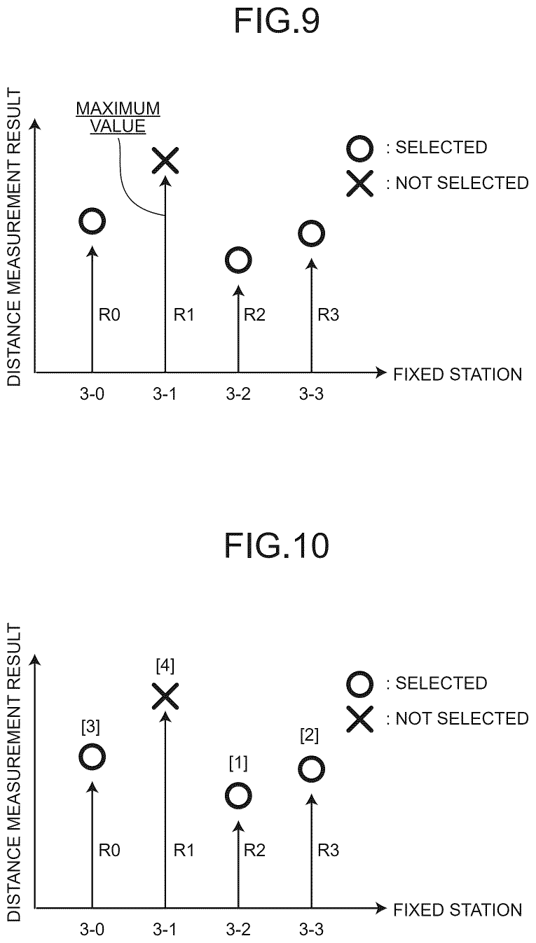

Hereinafter, an example of a detailed operation of the fixed station selection unit 19 will be described with reference to FIGS. 9 to 11. Here, suppose that the number of fixed stations is N=4 and the fixed station 3 to be used is selected from among the fixed stations 3-0 to 3-3. A circle in the drawings indicates the fixed station 3 to be selected, and a cross in the drawings indicates the fixed station 3 not to be selected. FIG. 9 is a diagram for explaining a first example of a selection method by the fixed station selection unit 19. In the first example, the fixed station selection unit 19 selects the fixed stations 3-0, 3-2, and 3-3, except the fixed station 3-1 which has a distance measurement result of the maximum value among the plurality of fixed stations 3. Here, it is determined that the distance measurement result with the maximum value is highly likely to include a distance measurement error due to waveform distortion in the UWB signal. Consequently, the positioning calculation unit 16A excludes the distance measurement result R1 and calculates the position using the distance measurement results R0, R2, and R3.

FIG. 10 is a diagram for explaining a second example of a selection method by the fixed station selection unit 19. In the second example, a predetermined number of fixed stations 3 necessary for positioning calculation are selected in ascending order of distance measurement results. The numerical values [1] to [4] in brackets in FIG. 10 are numbered in ascending order of distance measurement results. Here, suppose that the distance measurement results are, in ascending order of the distance measurement results, R2, R3, R0, and R1, and three fixed stations 3 are to be selected. In this case, the fixed station selection unit 19 selects the fixed stations 3-2, 3-3, and 3-0.

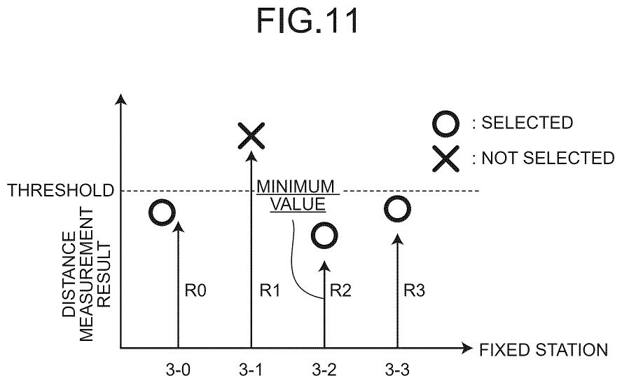

FIG. 11 is a diagram for explaining a third example of a selection method by the fixed station selection unit 19. In the third example, the fixed station selection unit 19 selects the fixed station 3 to be used using a threshold. There are various ways of setting a threshold, but here, the threshold is set based on the minimum value of the distance measurement result. For example, the fixed station selection unit 19 can generate the threshold by multiplying the minimum value of the distance measurement result by a predetermined coefficient. In the example illustrated in FIG. 11, among the distance measurement results R0 to R3, the distance measurement result R2 is the minimum value. The fixed station selection unit 19 can set the threshold by multiplying the distance measurement result R2 by a predetermined coefficient, and select the fixed station 3 having a distance measurement result smaller than the set threshold as the fixed station 3 to be used.

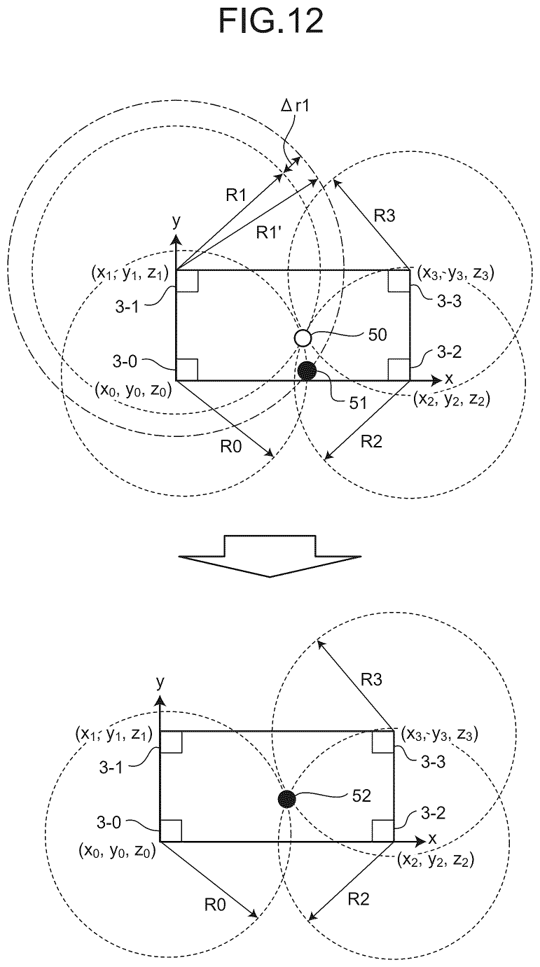

FIG. 12 is a diagram for explaining the effect of the second embodiment. In an upper figure above the arrow in FIG. 12, similarly to FIG. 8, a state in which a distance measurement error is included in the distance measurement result R1′ is illustrated. The distance measurement result R1′ is longer by Δr1 than the accurate distance measurement result R1 that does not include a distance measurement error. In this case, the position 51 that is the estimation result of the position of the mobile station 1A is a position shifted from the original position 50.

On the other hand, as illustrated in FIGS. 9 to 11, in a case where the fixed stations 3 to be used are selected based on the magnitude of the distance measurement results, the distance measurement result R1′ of the fixed station 3-1 is not selected. Therefore, the position of the mobile station 1A is a position 52 estimated based on the positions (x₀, y₀, z₀), (x₂, y₂, z₂), and (x₃, y₃, z₃) of the fixed stations 3-0, 3-2, and 3-3 and the distance measurement results R0, R2, and R3. In this manner, since positioning calculation can be performed based on the distance measurement results R0, R2, and R3 having no influence of distance measurement error or having a small distance measurement error, it is possible to reduce the estimation error included in the position 52 that is the estimation result.

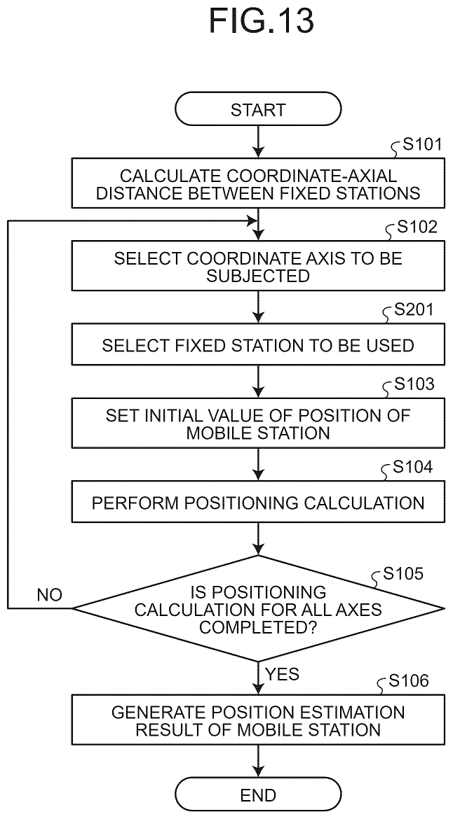

FIG. 13 is a flowchart for explaining the operation of the mobile station 1A according to the second embodiment. Here, after step S102 of selecting a target coordinate axis, the fixed station selection unit 19 selects the fixed station 3 to be used (step S201). Thereafter, the initial value setting unit 15 sets the initial value of the position of the mobile station 1A (step S103). The operation is similar to that in the first embodiment except that step S201 is performed between step S102 and step S103, and thus the detailed description thereof is omitted here.

As described above, the mobile station 1A according to the second embodiment further includes the fixed station selection unit 19 that selects the fixed station 3 to be used from among the plurality of fixed stations 3 based on the magnitude of the distance measurement results, in addition to the components of the mobile station 1 according to the first embodiment. The positioning calculation unit 16A excludes the distance measurement result of the fixed station 3 that has not been selected from the distance measurement results to be used for positioning calculation.

Specifically, the fixed station selection unit 19 selects, as the fixed stations 3 to be used, the fixed stations 3-0, 3-2, and 3-3 except the fixed station 3-1 having the maximum distance indicated by the distance measurement result from among the plurality of fixed stations 3-0, 3-1, 3-2, 3-3. Alternatively, the fixed station selection unit 19 selects a predetermined number of fixed stations 3 in ascending order of the distance indicated by the distance measurement result from among the plurality of fixed stations 3-0, 3-1, 3-2, and 3-3. Alternatively, the fixed station selection unit 19 selects, as the fixed station 3 to be used, the fixed station 3 having a distance indicated by the distance measurement result equal to or less than a threshold from among the plurality of fixed stations 3-0, 3-1, 3-2, and 3-3. At this time, the threshold is determined based on the minimum value of the distances indicated by the distance measurement results of the plurality of fixed stations 3-0, 3-1, 3-2, and 3-3. In this manner, by estimating the position of the mobile station 1A while excluding the distance measurement result of the fixed station 3 that is highly likely to include an error in the distance measurement result, it is possible to further improve the position estimation accuracy.

### Third Embodiment

The third embodiment describes a positioning method for use when the position of a mobile station 1B which is subjected to position estimation is known in advance on a part of the coordinate axes (namely, some coordinate axis). Such a situation may occur, for example, when there is a limitation on the route on which the mobile station 1B moves, such as the mobile station 1B mounted on a railway train traveling on a track or a vehicle traveling on a road.

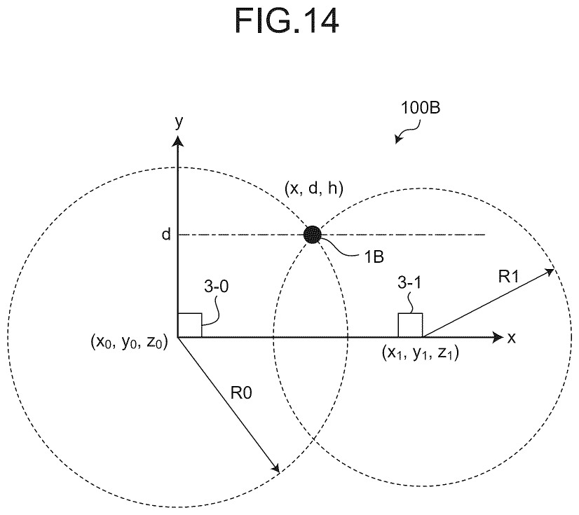

FIG. 14 is a diagram illustrating a configuration of a position estimation system 100B according to the third embodiment. Here, suppose that the plurality of fixed stations 3 exist on one coordinate axis, and the mobile station 1B moves on a line. Specifically, in the example illustrated in FIG. 14, suppose that two fixed stations 3-0 and 3-1 exist on the x-axis, and the mobile station 1B has a known position on the y-axis and a known position on the z-axis. Here, the position on the y-axis of the mobile station 1B is represented by d, the position on the z-axis is represented by h, and the position of the mobile station 1B is represented by (x, d, h). Note that the position of the fixed station 3-0 is (x₀, y₀, z₀), and the position of the fixed station 3-1 is (x₁, y₁, z₁). In addition, the distance measurement result for the fixed station 3-0 is R0, and the distance measurement result for the fixed station 3-1 is R1. Here, since the position on the y-axis and the position on the z-axis of the mobile station 1B are known, the mobile station 1B needs to perform position estimation only for the position on the x-axis, and can perform position estimation even with two fixed stations 3.

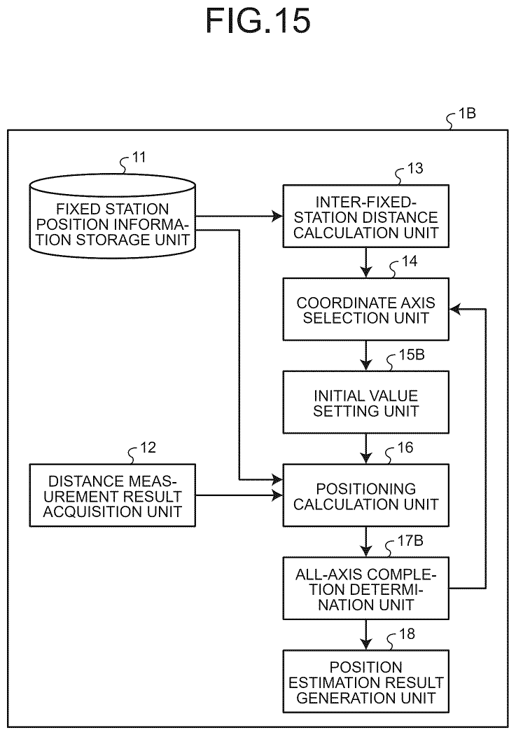

FIG. 15 is a diagram illustrating a functional configuration of the mobile station 1B according to the third embodiment. The mobile station 1B includes the fixed station position information storage unit 11, the distance measurement result acquisition unit 12, the inter-fixed-station distance calculation unit 13, the coordinate axis selection unit 14, an initial value setting unit 15B, the positioning calculation unit 16, an all-axis completion determination unit 17B, and the position estimation result generation unit 18. Hereinafter, differences from the first embodiment will be mainly described.

The inter-fixed-station distance calculation unit 13 calculates the distance between the fixed stations 3 for each coordinate axis. At this time, since N=2 and the fixed stations 3-0 and 3-1 are disposed on the x-axis, y₀=y₁ holds, and for the sake of simplicity, using Formulas (4) to (6) with z₀=z₁, the distance between the fixed stations 3 on the x-axis is expressed by Formula (14) below, the distance between the fixed stations 3 on the y-axis is expressed by Formula (15) below, and the distance between the fixed stations 3 on the z-axis is expressed by Formula (16) below.

$$\begin{matrix}Formula 14 & \\ {\sum }_{n = 0}^{N - 1} {\sum }_{m = n + 1}^{N - 1} \vert {x}_{n} - {x}_{m} \vert = \vert {x}_{0} - {x}_{1} \vert & ( 14 )\end{matrix}$$

$$\begin{matrix}Formula 15 & \\ {\sum }_{n = 0}^{N - 1} {\sum }_{m = n + 1}^{N - 1} \vert {y}_{n} - {y}_{m} \vert = \vert {y}_{0} - {y}_{1} \vert = 0 & ( 15 )\end{matrix}$$

$$\begin{matrix}Formula 16 & \\ {\sum }_{n = 0}^{N - 1} {\sum }_{m = n + 1}^{N - 1} \vert {z}_{n} - {z}_{m} \vert = \vert {z}_{0} - {z}_{1} \vert = 0 & ( 16 )\end{matrix}$$

The coordinate axis selection unit 14 selects the x-axis from Formulas (14) to (16) above. The initial value setting unit 15B calculates an average value of the fixed stations 3 with respect to the x-axis, which is the coordinate axis selected by the coordinate axis selection unit 14, and sets the average value as an initial value for positioning calculation by the least squares method. For example, in the case of the configuration illustrated in FIG. 14, since the number of fixed stations is N=2 and the positions on the y-axis and the z-axis of the mobile station 1B are known, the initial value setting unit 15B sets the initial value for positioning calculation to (xᵢₙ, d, h) using the initial value xᵢₙ of the position on the x-axis expressed by Formula (17) below, the initial value yᵢₙ of the position on the y-axis represented by Formula (18) below, and the initial value zᵢₙ of the position on the z-axis expressed by Formula (19) below. Note that, in a case where the position of the mobile station 1B is calculated in advance in terms of time, this position information may be given as the initial value.

$$\begin{matrix}Formula 17 & \\ {x}_{in} = \frac{1}{N} {\sum }_{n = 0}^{N - 1} {x}_{n} = 1 / 2 ( {x}_{0} + {x}_{1} ) & ( 17 )\end{matrix}$$

$$\begin{matrix}Formula 18 & \\ {y}_{in} = d & ( 18 )\end{matrix}$$

$$\begin{matrix}Formula 19 & \\ {z}_{in} = h & ( 19 )\end{matrix}$$

Based on the position information of each fixed station 3 and the distance measurement result, the positioning calculation unit 16 calculates the position of the mobile station 1B for each coordinate axis based on the least squares method. Here, in a case where the position of the mobile station 1B in the x-axis direction is estimated, the position of the mobile station 1B is set to (xₑₛₜ, d, h), and calculation is performed using the initial value xₑₛₜ=xᵢₙ of the variable of the x-axis to be subjected to positioning calculation. The distance rₙ between the n-th fixed station 3-n and the mobile station 1B is calculated based on Formula (20) below. Note that since rₙ in Formula (20) is a nonlinear function related to xₑₛₜ, the positioning calculation unit 16 sequentially calculates the variable of position estimation related to the x-axis based on the least squares method by sequential approximation using Formula (21) below as a norm.

$$\begin{matrix}Formula 20 & \\ {r}_{n} = \sqrt{{( {x}_{n} - {x}_{est} )}^{2} + {( {y}_{n} - d )}^{2} + {( {z}_{n} - h )}^{2}} & ( 20 )\end{matrix}$$

$$\begin{matrix}Formula 21 & \\ E = {\sum }_{n = 0}^{N - 1} {e}_{n}^{2} = {\sum }_{n = 0}^{N - 1} {( {R}_{n} - {r}_{n} )}^{2} = {( {R}_{0} - {r}_{0} )}^{2} + {( {R}_{1} - {r}_{1} )}^{2} & ( 21 )\end{matrix}$$

In Formula (20), n is an integer of zero to N−1. Formula (21) is a specific example of Formula (11) in the case of N=2.

The positioning calculation unit 16 outputs the x-axis position estimation result xₑₛₜ. In the third embodiment, since the position of the mobile station 1B is known for the y-axis and the z-axis, the all-axis completion determination unit 17 determines that the position estimation for all the coordinate axes is completed at a timing when the positioning calculation for the x-axis is completed, and outputs the calculation result of the coordinate-axial position of the mobile station 1B for each coordinate axis to the position estimation result generation unit 18. The position estimation result generation unit 18 outputs the position estimation result (xₑₛₜ, d, h) of the mobile station 1B.

In the above case, the positions of the y-axis and the z-axis are known, but in a case where only the position of the z-axis is known, the position estimation regarding the x-axis and the y-axis is performed. The coordinate axis with a known position may be any of the x-axis, the y-axis, and the z-axis.

As described above, in a case where the coordinate-axial position on at least one coordinate axis among the coordinate-axial positions of the all axes (namely, the coordinate-axial position on a part of the coordinate axes) is known, the mobile station 1B according to the third embodiment can perform positioning calculation for each coordinate axis in order from the coordinate axis having the largest distance between the fixed stations 3 using the known value. Consequently, the number of coordinate axes requiring calculation is reduced, and thus the position estimation accuracy can be maintained even with a smaller number N of fixed stations than in the case where calculation for all three axes is required. Such a situation can happen, for example, when the mobile station 1B is mounted on a mobile object moving along a predetermined route and the fixed stations 3 are installed along this route. For example, the mobile object can be a vehicle traveling along a road, a railway vehicle traveling along a track, or the like. In a case where this route is linear, if coordinate axes are set along the route, the mobile station 1B can estimate the three-dimensional position of the mobile station 1B just by estimating the position on one coordinate axis.

### Fourth Embodiment

A mobile station 1C according to the fourth embodiment has a function that in a case where the coordinate-axial position of the mobile station 1C for each coordinate axis is restricted to any of a plurality of axis position candidates for at least one of a plurality of coordinate axes, the position is identified from among a plurality of candidates for the position estimation result based on the estimation error for each candidate. Such a situation can occur, for example, in a case where the mobile station 1C is mounted on a railway vehicle traveling on a track, and it is not known which of a plurality of tracks the mobile station 1C is traveling on, or the track on which the mobile station 1C is traveling is known in advance and the installation distance of the fixed station 3 with respect to the track is determined in advance but it is not known on which side of the track the fixed station 3 is installed depending on the place.

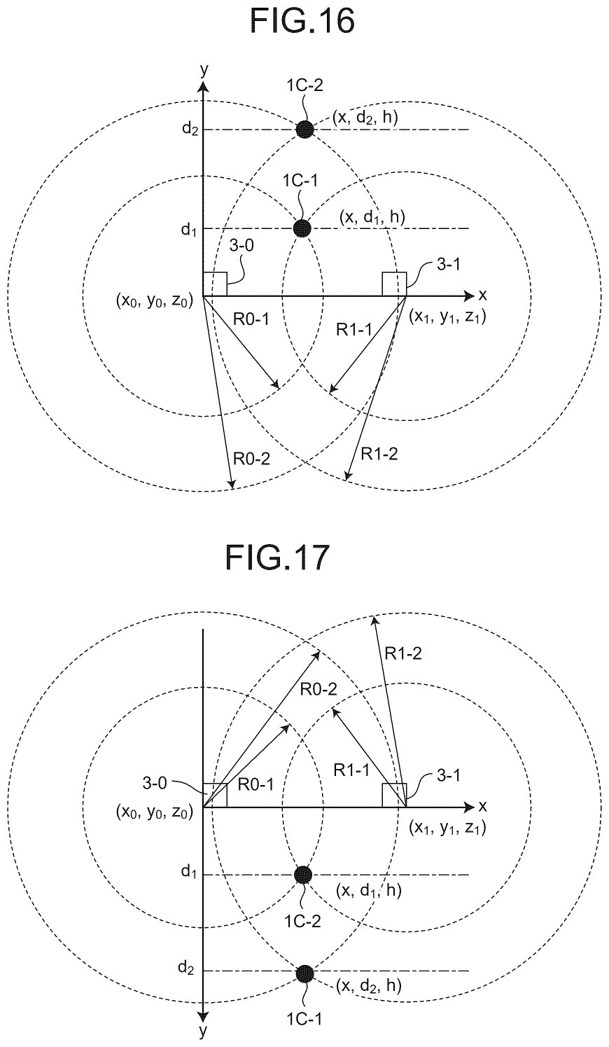

The latter situation will be described with reference to FIGS. 16 and 17. FIG. 16 is a diagram illustrating a first example of a positional relationship between the fixed stations 3 and the mobile station 1C according to the fourth embodiment. FIG. 17 is a diagram illustrating a second example of a positional relationship between the fixed stations 3 and the mobile station 1C according to the fourth embodiment. For example, an xy plane is defined as a ground on which a track is installed, and a direction parallel to the track is defined as an x-axis direction. For example, suppose that it is known in advance that a mobile station 1C-1 is mounted on a vehicle traveling on the track on the right side in the positive direction of the x-axis, and a mobile station 1C-2 is mounted on a vehicle traveling on the track on the left side. At this time, in a case where the installation rule of the fixed station 3 is that the fixed station 3 is to be installed at a distance d₁ from the nearest track, there are two possible positional relationships, i.e., the positional relationship illustrated in FIG. 16 and the positional relationship illustrated in FIG. 17.

Specifically, for example, in a case where the positive direction of the x-axis is north and the direction from the fixed station 3 toward the track is the positive direction of the y-axis, the fixed stations 3-0 and 3-1 can be located on the west side of the mobile stations 1C-1 and 1C-2 as illustrated in FIG. 16 or located on the east side of the mobile stations 1C-1 and 1C-2 as illustrated in FIG. 17. Here, in the presence of a plurality of candidates for the position estimation result as described above, the function of identifying which candidate is correct based on the estimation error will be described. Note that the mobile stations 1C-1 and 1C-2 exist on the left side of the fixed stations 3-0 and 3-1 in the state illustrated in FIG. 16 when facing the positive direction of the x-axis on the xy plane, and thus the state illustrated in FIG. 16 may be referred to as a case where the mobile station 1C exists on the left side of the fixed station 3. Similarly, the state illustrated in FIG. 17 may be referred to as a case where the mobile station 1C is on the right side of the fixed station 3.

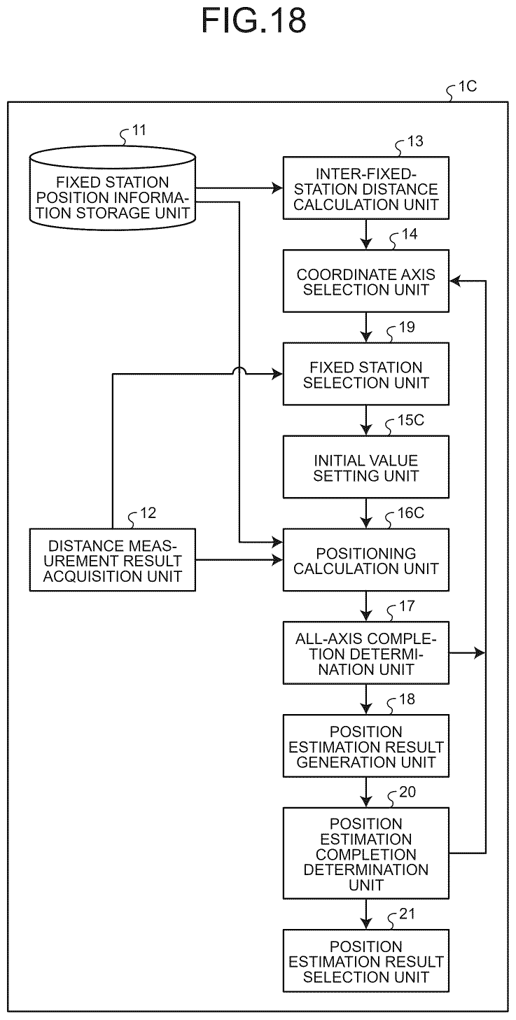

FIG. 18 is a diagram illustrating a functional configuration of the mobile station 1C according to the fourth embodiment. The mobile station 1C includes the fixed station position information storage unit 11, the distance measurement result acquisition unit 12, the inter-fixed-station distance calculation unit 13, the coordinate axis selection unit 14, the fixed station selection unit 19, an initial value setting unit 15C, a positioning calculation unit 16C, the all-axis completion determination unit 17, the position estimation result generation unit 18, a position estimation completion determination unit 20, and a position estimation result selection unit 21.

Hereinafter, differences from the second embodiment will be mainly described.

The coordinate-axial position of the mobile station 1C for each coordinate axis is restricted to any one of the plurality of axis position candidates for at least one of the plurality of coordinate axes. Here, suppose that the coordinate-axial position of the mobile station 1C is a known value h for the z-axis, and is one of the known values d₁ and d₂ for the y-axis.

The initial value setting unit 15C sets a plurality of initial values using each of the plurality of axis position candidates as the coordinate-axial position on a restricted axis, i.e. a coordinate axis restricted, here, the y-axis. Specifically, the initial value setting unit 15C sets two initial values of y=d₁ and y=d₂ as the initial values of the y-axis. Using each of the two initial values set by the initial value setting unit 15C, the positioning calculation unit 16C calculates two coordinate-axial positions for two coordinate axes, and error information indicating the degree of estimation error with respect to each position.

The position estimation result generation unit 18 generates two position estimation results using the two coordinate axial positions for two coordinate axes, and outputs the two position estimation results and the error information with respect to each position to the position estimation completion determination unit 20.

Once an assumed number of position estimation results and error information with respect to each position estimation result are calculated, the position estimation completion determination unit 20 determines that the position estimation is completed. In the above case, the position estimation completion determination unit 20 determines that the position estimation is completed once two position estimation results and two pieces of error information are calculated.

The position estimation result selection unit 21 selects a candidate for the position estimation result with the smallest measurement error of positioning from among a plurality of candidates for the position estimation result.

Presented below is a description of this procedure with a specific example. For example, in a case where it is not known whether the mobile station 1C exists at the position of the mobile station 1C-1 or the position of the mobile station 1C-2 illustrated in FIG. 16, the mobile station 1C can generate two candidates for the position estimation result: y=d₁ and y=d₂, and set the candidate having a smaller measurement error among the candidates for the position estimation result as the position of the mobile station 1C.

Alternatively, in a case where it is known that the mobile station 1C exists at the position of the mobile station 1C-1 illustrated in FIG. 16 or 17, but it is not known whether the positional relationship between the fixed station 3 and the mobile station 1C is the state illustrated in FIG. 16 or the state illustrated in FIG. 17, the mobile station 1C generates two candidates for the position estimation result, i.e., y=d₁ and y=d₂, and identifies the positional relationship between the mobile station 1C and the fixed station 3 based on the magnitude relationship of the values of the two estimation errors.

Specifically, the position information of the fixed station 3-0 is (x₀, y₀, z₀), and the position information of the fixed station 3-1 is (x₁, y₁, z₁). In addition, the distance measurement results between the fixed station 3-0 and the mobile station 1C are R0-1 and R0-2, and the distance measurement results between the fixed station 3-1 and the mobile station 1C are R1-1 and R1-2. In addition, d₁ is smaller than d₂.

In addition to the calculation result of the coordinate-axial position for each coordinate axis, the positioning calculation unit 16 calculates the sum of squares Eₘₖ of the distance errors expressed by Formula (22) below as error information indicating an estimation error of positioning, and outputs the calculation result.

$$\begin{matrix}Formula 22 & \\ {E}_{mk} = {\sum }_{n = 0}^{N - 1} {e}_{nm}^{2} = {\sum }_{n = 0}^{N - 1} {( {R}_{nm} - {r}_{nmk} )}^{2} = {( \text{?} - \text{?} )}^{2} + {( {R}_{1 m} - \text{?} )}^{2} & ( 22 )\end{matrix}$$

$$\text{?} \text{indicates text missing or illegible when filed}$$

Here, the m-th mobile station 1C is the mobile station 1C-m, and m is an integer of one to M, which is the number of mobile stations 1C. Given that the k-th axis position candidate on the y-axis of the mobile station 1C-m is dₖ and there are K axis position candidates, k is an integer of one to K. In addition, Rₙₘ represents a distance measurement result between the n-th fixed station 3-n and the m-th mobile station 1C-m. In addition, rₙₘₖ is an estimation result of the distance with the use of dₖ between the n-th fixed station 3-n and the m-th mobile station 1C-m, and is expressed by Formula (23) below.

$$\begin{matrix}Formula 23 & \\ {r}_{nmk} = \sqrt{{( {x}_{n} - {x}_{est} )}^{2} + {( {y}_{n} - {d}_{k} )}^{2} + {( {z}_{n} - h )}^{2}} & ( 23 )\end{matrix}$$

As illustrated in FIG. 16, when the mobile station 1C is located on the left side of the fixed station 3, the mobile station 1C-1 exists at the position of y=d₁, and the mobile station 1C-2 exists at the position of y=d₂. As illustrated in FIG. 17, when the mobile station 1C is located on the right side of the fixed station 3, the mobile station 1C-1 exists at the position of y=d₂, and the mobile station 1C-2 exists at the position of y=d₁.

Here, in a case where the positional relationship between the mobile station 1C and the fixed station 3 is in the state of FIG. 16, focusing on the sum of squares Eₘₖ Of the distance errors, in the mobile stations 1C-1 and 1C-2, two initial values y=d₁ and y=d₂ are set with respect to the y-axis, and in the position estimation completion determination unit 20, the position estimation is completed once two position estimation results with respect to the two initial values and the sums of squares E₁₁ and E₁₂ of the two distance errors are calculated. At this time, for the mobile station 1C-1, the magnitude relationship of the sum of squares of the distance errors is expected to be E₁₁<E₁₂. Similarly, for the mobile station 1C-2, E₂₁>E₂₂ is expected.

In a case where the positional relationship between the mobile station 1C and the fixed station 3 is in the state of FIG. 17, focusing on the sum of squares Eₘₖ Of the distance errors, in the mobile stations 1C-1 and 1C-2, two initial values y=d₁ and y=d₂ are set with respect to the y-axis, and in the position estimation completion determination unit 20, the position estimation is completed once two position estimation results with respect to the two initial values and the sums of squares E₁₁ and E₁₂ of the two distance errors are calculated. At this time, for the mobile station 1C-1, the magnitude relationship of the sum of squares of the distance errors is expected to be E₁₁>E₁₂. Similarly, for the mobile station 1C-2, E₂₁<E₂₂ is expected.

As described above, the magnitude relationship of the sum of squares of the distance errors varies depending on the positional relationship between the mobile station 1C and the fixed station 3. Using this relationship, the mobile station 1C can determine whether the positional relationship between the mobile station 1C and the fixed station 3 is the state of FIG. 16 or the state of FIG. 17. At this time, even with the two fixed stations 3, it is possible to output the estimation result of the position of the mobile station 1C regarding two coordinate axes such as the x-axis and the y-axis.

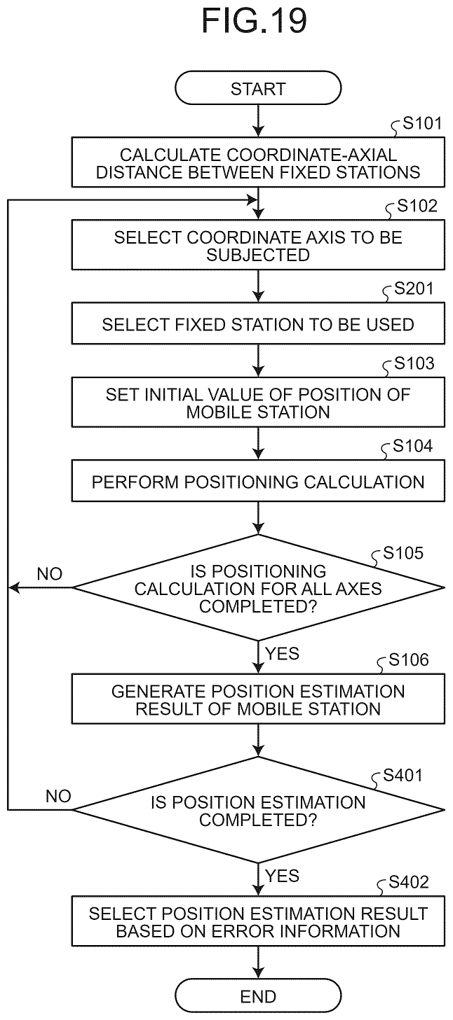

FIG. 19 is a flowchart for explaining the operation of the mobile station 1C according to the fourth embodiment. Steps S101 to S106 are the same as those in the second embodiment except that a plurality of initial values using a plurality of values of axis position candidates are set in step S103, and a plurality of coordinate-axial positions for the respective coordinate axes are calculated and error information with respect to the respective positions is output in step S104, and thus the detailed description thereof is omitted here.

Once the position estimation result is generated in step S106, the position estimation completion determination unit 20 determines whether the position estimation is completed (step S401). In response to a determination that the position estimation has not been completed (step S401: No), the mobile station 1C returns to step S102. In response to a determination that the position estimation is completed (step S401: Yes), the position estimation result selection unit 21 selects a position estimation result from among a plurality of candidates for the position estimation result based on the error information (step S402).

As described above, in the mobile station 1C according to the fourth embodiment, in a case where the coordinate-axial position of the mobile station 1C is restricted to any of a plurality of axis position candidates for at least one of a plurality of the coordinate axes, the positioning calculation unit 16C calculates the coordinate-axial position with respect to a coordinate axis except a restricted axis that is the coordinate axis restricted using each of the plurality of axis position candidates as the coordinate-axial position of the restricted axis. The position estimation result generation unit 18 generates a plurality of candidates for the position estimation result using each of the plurality of axis position candidates. The mobile station 1C further includes a position estimation result selection unit 21 that selects a candidate for the position estimation result with a minimum estimation error of positioning from among the plurality of candidates for the position estimation result. Consequently, even when there are a plurality of axis position candidates, the actual position of the mobile station 1C can be estimated based on the estimation error. At this time, even when the number of available fixed stations 3 is small, it is possible to maintain the position estimation accuracy while reducing the degree of freedom of variables necessary for position estimation.

### Fifth Embodiment

The above second embodiment has described an example in which since there is a high possibility that the error included in the distance measurement result of the fixed station 3 at a large distance from the mobile station 1A is large, the fixed station 3 to be used is selected based on the magnitude of the distance measurement result. However, it is not necessarily the case that the distance measurement error increases as the distance measurement result increases. Which fixed station 3 is actually affected by a reflected wave in its distance measurement result is not known only by the magnitude of the distance measurement result. Therefore, in the fifth embodiment, error information associated with performing positioning calculation in a plurality of patterns in which combinations of fixed stations 3 to be used are changed is calculated, and the distance measurement result to be used for positioning calculation is weighted based on the error information, thereby reducing the influence of the distance measurement result considered to have low accuracy.

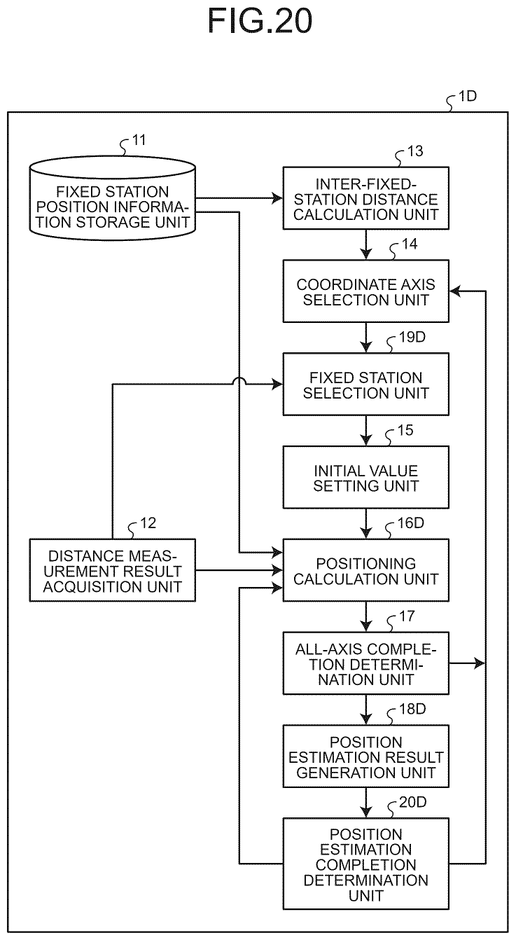

FIG. 20 is a diagram illustrating a functional configuration of a mobile station 1D according to the fifth embodiment. The mobile station 1D includes the fixed station position information storage unit 11, the distance measurement result acquisition unit 12, the inter-fixed-station distance calculation unit 13, the coordinate axis selection unit 14, a fixed station selection unit 19D, the initial value setting unit 15, a positioning calculation unit 16D, the all-axis completion determination unit 17, a position estimation result generation unit 18D, and a position estimation completion determination unit 20D. Hereinafter, differences from the fourth embodiment will be mainly described.

The fixed station selection unit 19D selects the fixed station 3 to be used such that the positioning calculation unit 16D can perform positioning calculation in a plurality of patterns of combinations of the fixed stations 3 to be used. Reference is now made again to FIG. 12. As illustrated in FIG. 12, in a case where the distance measurement result R1′ for the fixed station 3-1 has a large distance measurement error, if positioning calculation can be performed excluding the distance measurement result R1′, it is possible to reduce the influence of the distance measurement error and improve the position estimation accuracy. However, in an actual radio wave propagation environment, it is not known which fixed station 3 is affected by distortion due to a reflected wave. Therefore, the fixed station selection unit 19D selects the fixed stations 3 such that the “combinations of the fixed stations 3 to be used” are in a plurality of patterns in which the fixed stations 3 excluded are changed one by one.

The positioning calculation unit 16D calculates, as error information, the sum of squares Eₚ of distance errors expressed by Formula (24) below for a plurality of patterns in which the fixed stations 3-p excluded are changed one by one. Here, p is an integer of zero to N−1.

$$\begin{matrix}Formula 24 & \\ {E}_{p} = \text{?} {e}_{n}^{2} = \text{?} {( {R}_{n} - {r}_{n} )}^{2} & ( 24 )\end{matrix}$$

$$\text{?} \text{indicates text missing or illegible when filed}$$

As shown in Formula (24), in order to change and acquire the parameter p of the sum of squares of distance errors from zero to N−1, the fixed station selection unit 19D changes the value of the parameter p so as to change the combination of the fixed stations 3 to be used each time the process of selecting the fixed stations 3 is performed. Specifically, the fixed station selection unit 19D first sets p=0 to select the fixed stations 3 to be used so as to exclude the zero-th fixed station 3-0, then sets p=1 to select the fixed stations 3 to be used so as to exclude the first fixed station 3-1, and similarly sets p=2 and p=3 to select the fixed stations 3 to be used. For each combination of the fixed stations 3 to be used, the positioning calculation unit 16D calculates the sum of squares Eₚ of the distance errors. For example, as illustrated in FIG. 12, in a case where the distance measurement result R1′ for the fixed station 3-1 has a large distance measurement error, the sum of squares E₁ of the distance errors calculated excluding the fixed station 3-1 takes the smallest value. In addition, since the fixed station 3-0 which is at the same position on the x-axis as the fixed station 3-1 has a greater degree of dependence than the fixed station 3-1, it is expected that the magnitude relationship of the sum of squares Eₚ of the distance errors obtained for each fixed station 3 is E₁<(E₂, E₃)<E₀. Thus, since the sum of squares Eₚ of distance errors becomes larger as the distance measurement error included in the distance measurement result Rp for the p-th fixed station 3-p decreases, it can be said that Eₚ represents the degree of dependence or the degree of reliability in using the p-th fixed station 3-p for position estimation. A weighting coefficient wₙ that is based on this degree of dependence is expressed by, for example, Formula (25) below.

$$\begin{matrix}Formula 25 & \\ {w}_{n} = {E}_{n} / {\sum }_{n = 0}^{N - 1} {E}_{n} & ( 25 )\end{matrix}$$

Here, n represents the number of the fixed station 3. Here, normalization is performed with the total value of the sum of squares of distance errors for all the fixed stations 3, but for the sake of simplicity, wₙ=Eₙ may be set. Once error information is calculated for all the patterns of combinations of the fixed stations 3 to be used, the positioning calculation unit 16D estimates the position of the mobile station 1D for each coordinate axis using the weighting coefficient wₙ based on the least squares method by sequential approximation for minimizing the weighted sum of squares E of the distance errors corresponding to the N fixed stations as expressed by Formula (26) below.

$$\begin{matrix}Formula 26 & \\ E = {\sum }_{n = 0}^{N - 1} {w}_{n} {e}_{n}^{2} = {\sum }_{n = 0}^{N - 1} {{w}_{n} ( {R}_{n} - {r}_{n} )}^{2} & ( 26 )\end{matrix}$$

The all-axis completion determination unit 17 determines whether positioning calculation has been completed for all coordinate axes for which position estimation should be performed. In response to a determination that positioning calculation is completed for all the target coordinate axes, the position estimation result generation unit 18D outputs (xₑₛₜ, yₑₛₜ, zₑₛₜ) as the position estimation result.

Note that, in the above description, the weighting coefficient wₙ, which is calculated based on the sum of squares Eₙ of distance errors and is expressed by Formula (25), has been used; however, for the sake of simplicity, the weighting coefficient wₙ may be set to a value of zero or one depending on the magnitude of the sum of squares Eₙ of distance errors as expressed by Formula (27) below. Here, ε is a predetermined reliability threshold, and when Eₙ indicating the degree of reliability is less than the reliability threshold, the value of the weighting coefficient wₙ is set to zero, and when Eₙ is equal to or greater than the reliability threshold, the value of the weighting coefficient wₙ is set to one. Consequently, positioning calculation is performed excluding the distance measurement result of the fixed station 3 having a degree of reliability less than the reliability threshold. Here, n is an integer of zero to N−1.

$$\begin{matrix}Formula 27 & \\ \{ \begin{matrix}{w}_{n} = 0 , & if {E}_{n} < ε \\ {w}_{n} = 1 , & if {E}_{n} \geq ε\end{matrix} & ( 27 )\end{matrix}$$

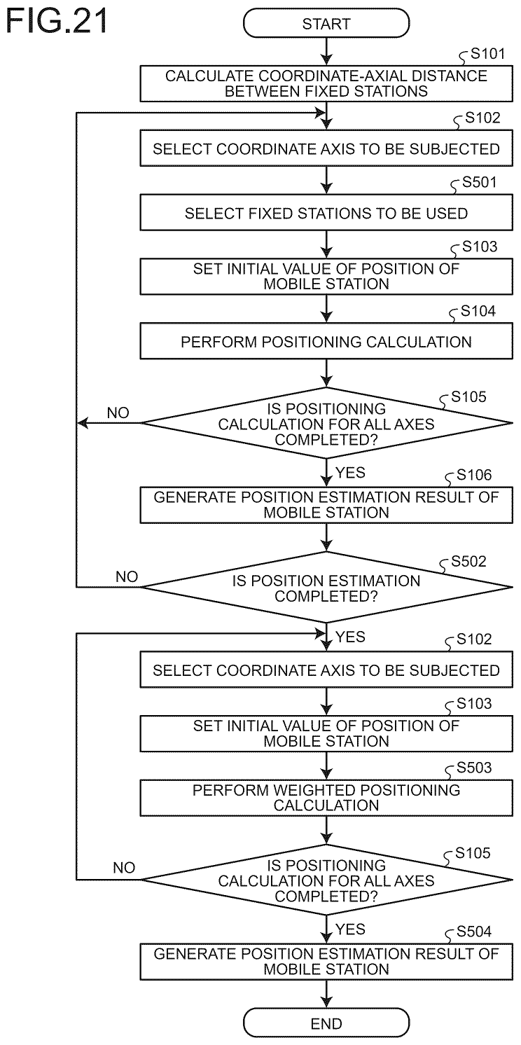

FIG. 21 is a flowchart for explaining the operation of the mobile station 1D according to the fifth embodiment. Steps S101 and S102 are the same as those in FIG. 19 or the like. Subsequently, the fixed station selection unit 19D selects the fixed stations 3 to be used (step S501). In step S501, a combination of the fixed stations 3 to be used is selected such that the fixed station 3 to be excluded changes each time selection is made. Subsequent steps S103 to S106 are the same as those in FIG. 19.

When positioning calculation for all the axes is completed and the degree of reliability is calculated for each calculation result, the position estimation completion determination unit 20D determines whether position estimation is completed (step S502). In response to a determination that position estimation has not been completed (step S502: No), the mobile station 1D returns to step S102. In response to a determination that position estimation is completed (step S502: Yes), the mobile station 1D again performs steps S102 and S103, and performs positioning calculation using the weighting coefficient (step S503). Thereafter, the all-axis completion determination unit 17 determines whether positioning calculation for all axes is completed (step S105). In response to a determination that positioning calculation for all axes has not been completed (step S105: No), the mobile station 1D returns to step S102 after step S502. In response to a determination that positioning calculation for all axes is completed (step S105: Yes), the position estimation result generation unit 18D generates a position estimation result indicating the three-dimensional position of the mobile station 1D based on the calculation result of the weighted positioning calculation (step S504).

As described above, in the mobile station 1D according to the fifth embodiment, the fixed station selection unit 19D selects a combination of the fixed stations 3 to be used such that the fixed station 3 to be excluded changes each time. Consequently, the positioning calculation unit 16D can calculate the coordinate-axial position for each coordinate axis a plurality of times while changing the distance measurement result to be excluded, and generate error information indicating a degree of estimation error of each of a plurality of the coordinate-axial positions calculated. The positioning calculation unit 16D can calculate the coordinate-axial position for each coordinate axis again based on the distance measurement result weighted based on the error information. The position estimation result generation unit 18 can generate the position estimation result using the coordinate-axial position for coordinate axial that is based on the distance measurement result weighted. Consequently, it is possible to more reliably reduce the influence of the fixed station 3 which includes an error in the distance measurement result and has low distance measurement accuracy, and to improve the position estimation accuracy.

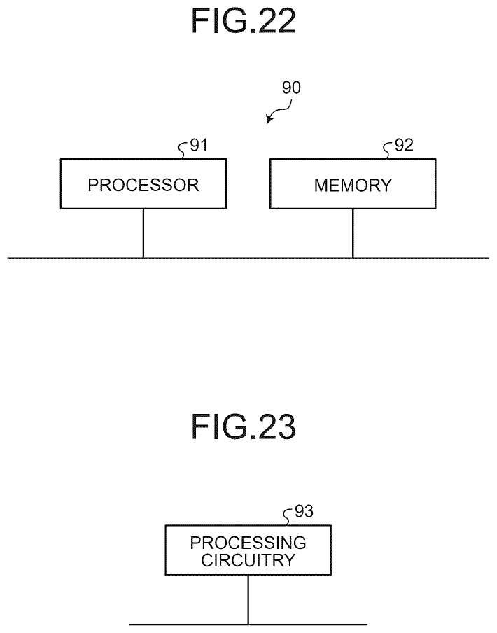

Here, exemplary configurations of processing circuitry included in the fixed station 3 or the mobile stations 1, 1A, 1B, 1C, and 1D according to the first to fifth embodiments will be described. When the processing circuitry is implemented by a control circuit using a processor, the control circuit is, for example, a control circuit 90 illustrated in FIG. 22. FIG. 22 is a diagram illustrating a configuration of the control circuit 90 included in the fixed station 3 or the mobile stations 1, 1A, 1B, 1C, and 1D according to the first to fifth embodiments.

The control circuit 90 includes a processor 91 and a memory 92. In a case where the processing circuitry is configured by the control circuit 90 including the processor 91 and the memory 92, each function of the fixed station 3 or the mobile stations 1, 1A, 1B, 1C, and 1D is implemented by software, firmware, or a combination of software and firmware. Software or firmware is described as a program and stored in the memory 92. The processor 91 reads and executes the program stored in the memory 92, thereby implementing each function. That is, the processing circuitry includes the memory 92 for storing a program that results in the processing of the fixed station 3 or the mobile stations 1, 1A, 1B, 1C, and 1D. It can also be said that these programs cause a computer to execute the procedures or methods for the fixed station 3 or the mobile stations 1, 1A, 1B, 1C, and 1D. The program may be provided in a state that it is stored in a storage medium, or may be provided via a communication path.

The processor 91 may be a central processing unit (CPU), a processing device, an arithmetic device, a microprocessor, a microcomputer, or a digital signal processor (DSP). Examples of the memory 92 include a non-volatile or volatile semiconductor memory, a magnetic disk, a flexible disk, an optical disc, a compact disc, a mini disc, a digital versatile disc (DVD), and the like. Examples of non-volatile or volatile semiconductor memories include a random access memory (RAM), a read only memory (ROM), a flash memory, an erasable programmable ROM (EPROM), an electrically EPROM (EEPROM, registered trademark), and the like.

In addition, processing circuitry included in the fixed station 3 or the mobile stations 1, 1A, 1B, 1C, and 1D according to the first to fifth embodiments may be configured using dedicated hardware. FIG. 23 is a diagram illustrating an example of dedicated hardware included in the fixed station 3 or the mobile stations 1, 1A, 1B, 1C, and 1D according to the first to fifth embodiments. For example, a processing circuitry 93 illustrated in FIG. 23 is a single circuit, a composite circuit, a programmed processor, a parallel programmed processor, an application specific integrated circuit (ASIC), a field programmable gate array (FPGA), or a combination thereof. The functions of the fixed station 3 or the mobile stations 1, 1A, 1B, 1C, and 1D may be implemented by the processing circuitry 93 separately or collectively.

Note that some of the functions of the fixed station 3 or the mobile stations 1, 1A, 1B, 1C, and 1D according to the first to fifth embodiments may be implemented by dedicated hardware, and the other functions may be implemented by software or firmware. In this manner, the processing circuitry can implement each of the above-described functions by means of dedicated hardware, software, firmware, or a combination thereof.

The configurations described in the above-mentioned embodiments indicate examples. The embodiments can be combined with another well-known technique and with each other, and some of the configurations can be omitted or changed in a range not departing from the gist.

For example, in the above-described first to fifth embodiments, the mobile stations 1, 1A, 1B, 1C, and 1D are position estimation devices that estimate the positions of the mobile stations 1, 1A, 1B, 1C, and 1D. However, the technique described in the present embodiments is not limited to such an example, and a device different from the mobile stations 1, 1A, 1B, 1C, and 1D may acquire distance measurement results and perform similar position estimation processing. In addition, it is not necessary to implement all the functions of the illustrated functional units with one device, and the functions of the position estimation device can be shared and implemented by a plurality of devices. Some or all of the functions of the position estimation device may be implemented on a cloud server. In a case where all the functions of the position estimation device are performed by a cloud server or a device different from the mobile stations 1, 1A, 1B, 1C, and 1D, the distance measurement processing needs to be performed between the mobile stations 1, 1A, 1B, 1C, and 1D and the fixed station 3. Therefore, the distance measurement result acquisition unit 12 acquires distance measurement results from the mobile stations 1, 1A, 1B, 1C, and 1D or the fixed station 3.

The position estimation device according to the present disclosure can achieve the effect of performing position estimation with high accuracy even in a case where accurate statistical data of multipath components of a received signal cannot be obtained in advance.

What is claimed is:

1. A position estimation device that estimates a position of a mobile station based on a plurality of distance measurement results measured between each of a plurality of fixed stations and the mobile station using wireless communication, the position estimation device comprising:
positioning calculation circuitry to calculate a coordinate-axial position of the mobile station for each coordinate axis using a position of the fixed stations and the distance measurement results in order from a coordinate axis having a largest coordinate-axial distance between the plurality of fixed stations; and
position estimation result generation circuitry to generate a position estimation result indicating a three-dimensional position of the mobile station based on a calculation result of the coordinate-axial position.

2. The position estimation device according to claim 1, further comprising
fixed station selection circuitry to select a fixed station to be used from among the plurality of fixed stations based on magnitude of the distance measurement results, wherein
the positioning calculation circuitry excludes the distance measurement result of the fixed station that has not been selected, from the distance measurement results to be used for the calculation.

3. The position estimation device according to claim 2, wherein the fixed station selection circuitry selects, as the fixed station to be used, a fixed station except a fixed station having a maximum distance indicated by the distance measurement result from among the plurality of fixed stations.

4. The position estimation device according to claim 2, wherein the fixed station selection circuitry selects a predetermined number of the fixed stations in ascending order of a distance indicated by the distance measurement result from among the plurality of fixed stations.

5. The position estimation device according to claim 2, wherein the fixed station selection circuitry selects, as the fixed station to be used, a fixed station having a distance indicated by the distance measurement result equal to or less than a threshold from among the plurality of fixed stations.

6. The position estimation device according to claim 5, wherein the threshold is determined based on a minimum value of distances indicated by the distance measurement results of the plurality of fixed stations.

7. The position estimation device according to claim 1, wherein
in a case where the coordinate-axial position of the mobile station is restricted to one of a plurality of axis position candidates for at least one of a plurality of the coordinate axes,
the positioning calculation circuitry calculates the coordinate-axial position with respect to a coordinate axis except a restricted axis that is the coordinate axis restricted using each of the plurality of axis position candidates as the coordinate-axial position of the restricted axis,
the position estimation result generation circuitry generates a plurality of candidates for the position estimation result using each of the plurality of axis position candidates, and
the position estimation device includes estimation result selection circuitry to select a candidate for the position estimation result with a minimum estimation error of positioning from among the plurality of candidates for the position estimation result.

8. The position estimation device according to claim 2, wherein
the positioning calculation circuitry calculates the coordinate-axial position a plurality of times while changing the distance measurement result to be excluded, and generates error information indicating a degree of estimation error of each of a plurality of the coordinate-axial positions calculated,
the positioning calculation circuitry calculates the coordinate-axial position again based on the distance measurement result weighted based on the error information, and
the position estimation result generation circuitry generates the position estimation result using the coordinate-axial position that is based on the distance measurement result weighted.

9. The position estimation device according to claim 8, wherein the positioning calculation circuitry sets a weighting coefficient of one when a degree of reliability of the distance measurement result of the fixed station that is based on the error information is equal to or greater than a reliability threshold predetermined, and sets a weighting coefficient of zero when the degree of reliability is less than the reliability threshold.

10. The position estimation device according to claim 1, wherein the distance measurement results are obtained based on a transmission/reception timing of an ultra-wide band wireless signal between the fixed stations and the mobile station.

11. The position estimation device according to claim 1, wherein the positioning calculation circuitry calculates the coordinate-axial position based on a least squares method by sequential approximation.

12. A position estimation system comprising:
the mobile station including the position estimation device according to claim 1; and
the fixed stations.

13. The position estimation system according to claim 12, wherein
the mobile station is mounted on a mobile object that moves along a predetermined route, and
the fixed stations are installed along the route.

14. The position estimation system according to claim 13, wherein the mobile object is a railway vehicle traveling on a track or a vehicle traveling on a road.

15. The position estimation system according to claim 13, wherein
the fixed stations are installed along the route that is linear, and
the position estimation device estimates a position of the mobile station on one coordinate axis.

16. A control circuit that controls a position estimation device that estimates a position of a mobile station based on a plurality of distance measurement results measured between each of a plurality of fixed stations and the mobile station using wireless communication, the control circuit causing the position estimation device to perform processes of:
calculating a coordinate-axial position of the mobile station for each coordinate axis using a position of the fixed stations and the distance measurement results in order from a coordinate axis having a largest coordinate-axial distance between the plurality of fixed stations; and
generating a position estimation result indicating a three-dimensional position of the mobile station based on a calculation result of the coordinate-axial position.

17. A non-transitory computer-readable storage medium that stores a program for controlling a position estimation device that estimates a position of a mobile station based on a plurality of distance measurement results measured between each of a plurality of fixed stations and the mobile station using wireless communication, wherein the program causes the position estimation device to perform processes of:
calculating a coordinate-axial position of the mobile station for each coordinate axis using a position of the fixed stations and the distance measurement results in order from a coordinate axis having a largest coordinate-axial distance between the plurality of fixed stations; and
generating a position estimation result indicating a three-dimensional position of the mobile station based on a calculation result of the coordinate-axial position.

18. A position estimation method for estimating a position of a mobile station based on a plurality of distance measurement results measured between each of a plurality of fixed stations and the mobile station using wireless communication, the position estimation method comprising:
calculating a coordinate-axial position of the mobile station for each coordinate axis using a position of the fixed stations and the distance measurement results in order from a coordinate axis having a largest coordinate-axial distance between the plurality of fixed stations; and
generating a position estimation result indicating a three-dimensional position of the mobile station based on a calculation result of the coordinate-axial position.
